(19) United States
(12) Patent Application Publication
(10) Pub. No.: US 2008/0254182 A1
(43) Pub. Date: Oct. 16, 2008

(54) Packaged Flowable Ice Product, Such as a Milk Shake

(76) Inventor: Laurens Last, Monaco (MC)

Correspondence Address: HOFFMANN & BARON, LLP, 6900 JERICHO TURNPIKE, SYOSSET, NY, 11791, US

(21) Appl. No.: 11/587,914

(22) PCT Filed: Apr. 26, 2004
(86) PCT No.: PCT/NL2004/000275

§ 371 Date: Jan. 23, 2007

(51) Int. Cl. A23G 9/28; B67D 5/62

(52) U.S. Cl. 426/524; 222/146.6; 426/232

(57) ABSTRACT

A combination of a machine for making and dispensing a flowable ice product such as e.g. soft ice-cream, ice cream slush, in particular milk shake, and a package for the flowable ice product. The machine for making and dispensing the flowable ice product comprises an ice product making assembly including a cooler or freezer unit, and a dispenser unit for dispensing the ice product The dispenser unit is connected to the ice product making assembly and to outlet means of the machine. The flowable ice product can be fed from the outlet means of the machine to the package for the flowable ice product. The package is a collapsible pouch comprising inlet means.

The present invention relates to the distribution of flowable ice products, in particular of milk shakes, to customers.

In many (fast-food) restaurants milk shakes are produced with a machine from companies like Taylor and Carpigiani, an embodiment of which is shown in U.S. Pat. No. 5,382,090. Such a machine in general has a milk shake making assembly including a cooler or freezer unit. Also the machine has a dispenser unit and outlet means for the milk shake.

In the known machine a holder for a beaker is provided so that the beaker is positioned beneath the outlet means and a portion of milk shake is dispensed into the beaker. In known advanced machines of this type a temperature sensor is present, which senses the temperature of the upper region of the beaker. When the cold milk shake has reached the height of the sensor, the sensor gives off a signal and the machine stops dispensing.

It is noted that the present invention not only relates to milk shakes but also application for other consumable flowable ice products such as soft ice-cream, ice cream slushes is envisaged.

The present invention aims to provide an alternative manner to deliver the flowable ice product to the consumer.

The present invention proposes to use a collapsible pouch as consumer handled package for the flowable ice product. Such a pouch is an attractive alternative for a beaker, particularly for children.

In a preferred embodiment, closure means are associated with the pouch so that the pouch can be closed after being filled with the flowable ice product, to prevent spilling.

Another advantage of a collapsible pouch is the wide range of filling volumes that is possible with pouches. Preferably, the volume of the pouch is between 100 ml and 250 ml. A further advantage is the small volume of the packaging material of the pouch, beneficial both for the supply to the machine and for the consumer.

The present invention also envisages that the vendor can use a single machine in combination with pouches and with beakers, so that the consumer has the option to select the pouch or beaker.

In particular the present invention envisages that existing machines, in particular milk shake machines, are modified such that they can be used in combination with pouches, preferably without taking away the option to use the machine in combination with beakers.

Preferably, the pouch is a brick-shaped, side-gusset pouch. In an embodiment, the pouch comprises a thermally insulating shell, for example a foam layer. The pouch can also comprise a paper layer.

The invention also provides a solution for supporting the pouch, and for filling the pouch.

In a preferred embodiment, the inlet means of the pouch and the outlet means of the machine are adapted both to connect the pouch to the machine and to form a passage for the ice product between the pouch and the machine. Preferably, the machine is provided with pouch securing means which engage on the inlet means of the pouch. For example, the pouch comprises one or more external flanges upon which the pouch securing means can engage. These pouch securing means are preferably self-locking, so the pouch can be easily be connected to the machine, for example by a snap-connection.

Furthermore, measures for sensing the filled volume of the pouch have been developed.

A preferred embodiment of sensing the filled pouch volume is envisaged in particular in combination with existing machine designs having a temperature sensor for detecting the filling level in a beaker. In this embodiment blinding means are provided which blind the temperature sensor, as present already on such existing machines, during filling of the pouch, in particular until the desired volume has been filled into the pouch.

In a preferred embodiment the sensing comprises the use of mechanical means engaging on the pouch which sense that a desired volume of the pouch is filled and then act to remove the blinding of the temperature sensor. Then the sensor registers the cold surface of the pouch and gives of a signal which results in that the machine stops the dispensing of ice product.

In another embodiment the pouch includes a blinding means, which cooperates with the temperature sensor.

The invention will now be explained in detail with reference to preferred embodiments. In the drawings:

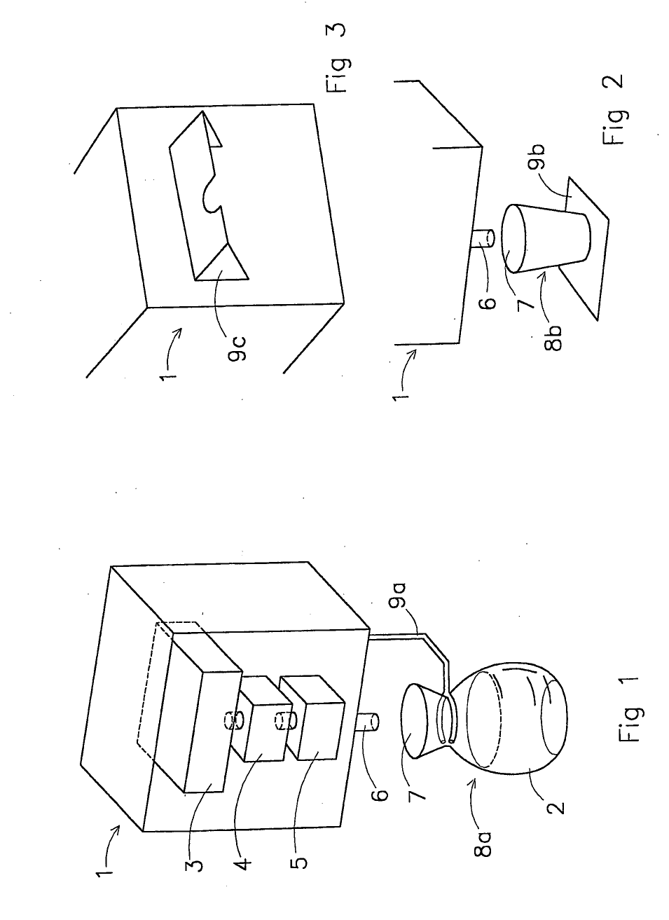

FIG. 1 is a perspective view of a preferred combination according to the invention,

FIG. 2 shows a detail of an embodiment of the combination according to the invention,

FIG. 3 shows a detail of an embodiment of package support means,

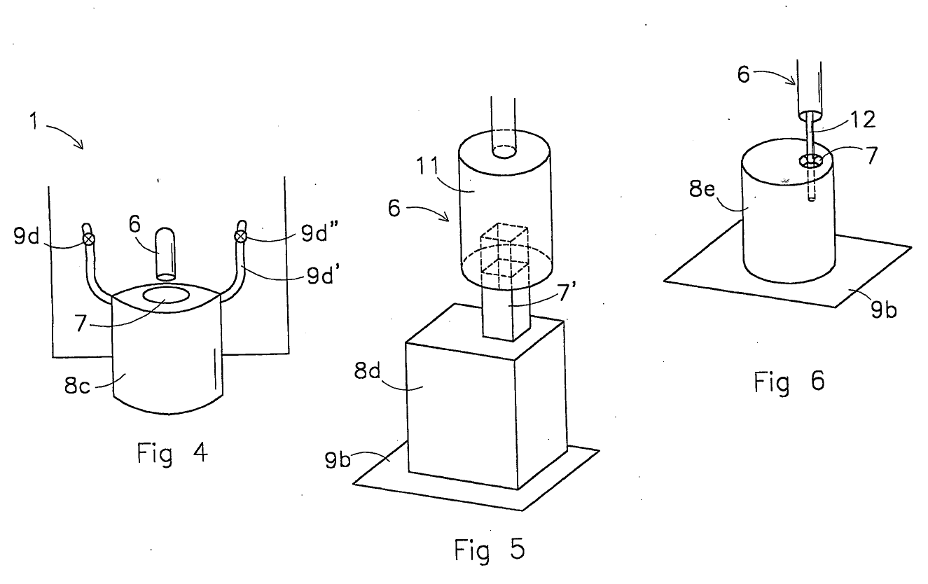

FIG. 4 shows a detail of another embodiment of package support means,

FIG. 5 shows a detail of an embodiment of a passage formed by a nozzle,

FIG. 6 shows another embodiment of a connection between the outlet means of a machine and the inlet means of the pouch,

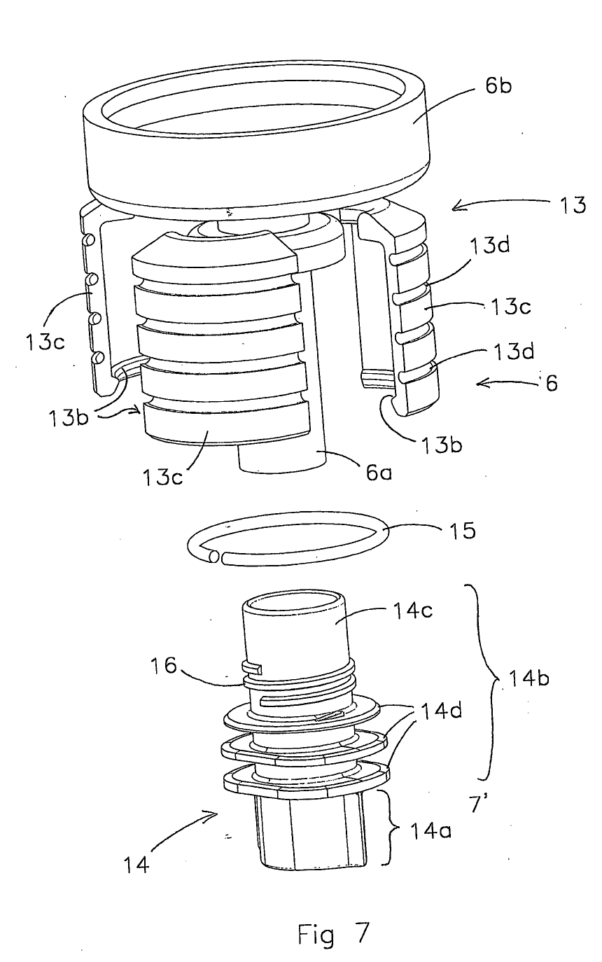

FIG. 7 shows an embodiment of connection means that form a fluid-tight passage between the inlet means of the pouch and the outlet means of the machine,

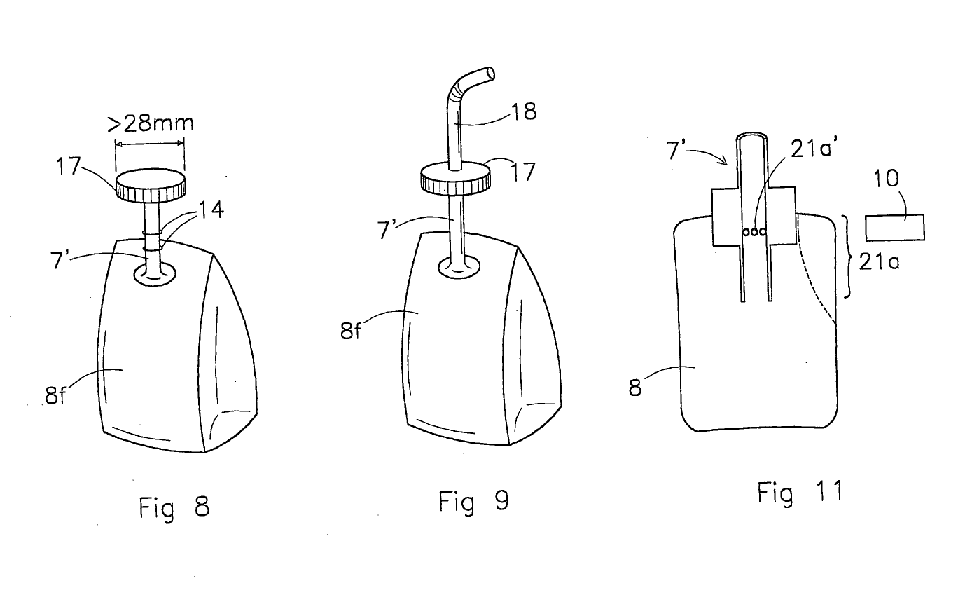

FIG. 8 shows an example of a closed-off pouch,

FIG. 9 shows another example of a closed-off pouch,

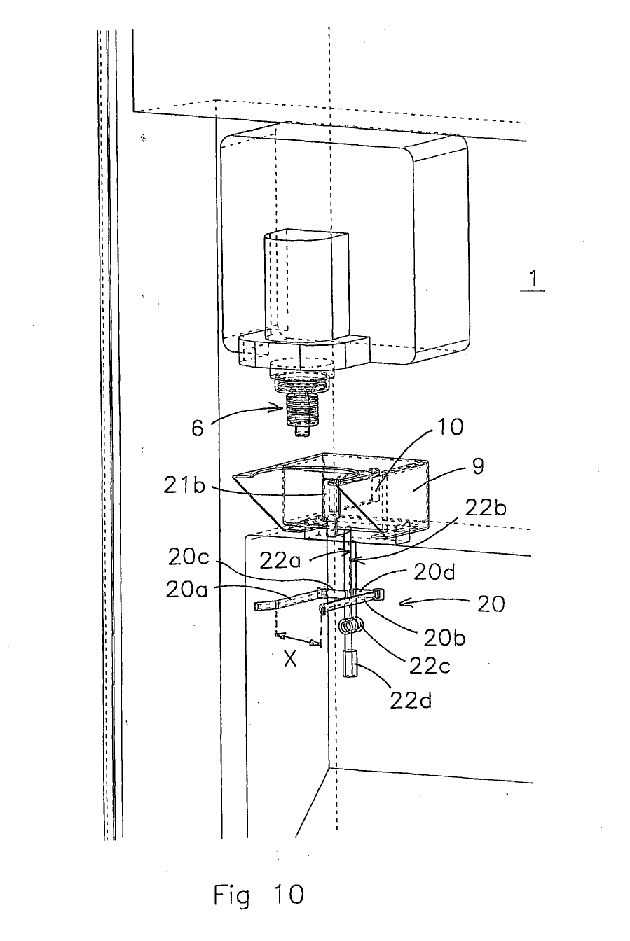

FIG. 10 shows an embodiment of a combination according to the invention without a pouch,

FIG. 11 shows another embodiment of a pouch according to the invention,

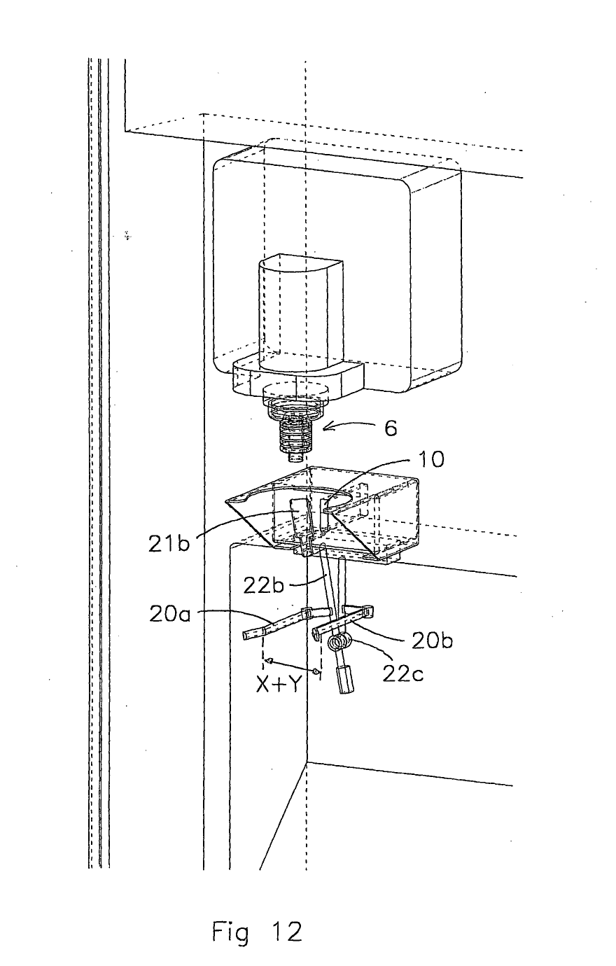

FIG. 12 shows the same embodiment of a combination according to the invention as shown in FIG. 10 in a different position,

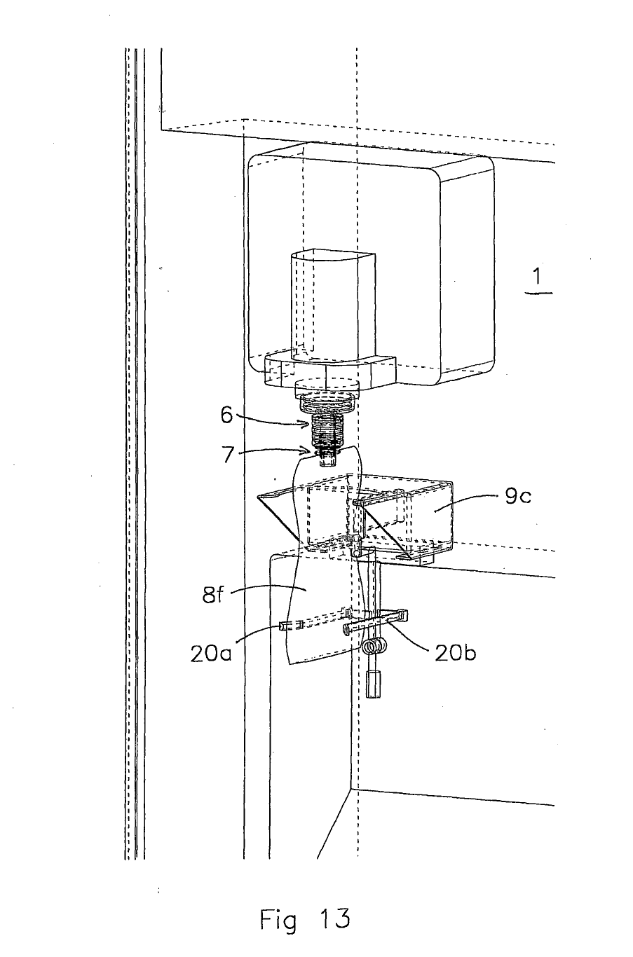

FIG. 13 shows the same embodiment of a combination according to the invention as shown in FIG. 10 with an empty collapsible pouch,

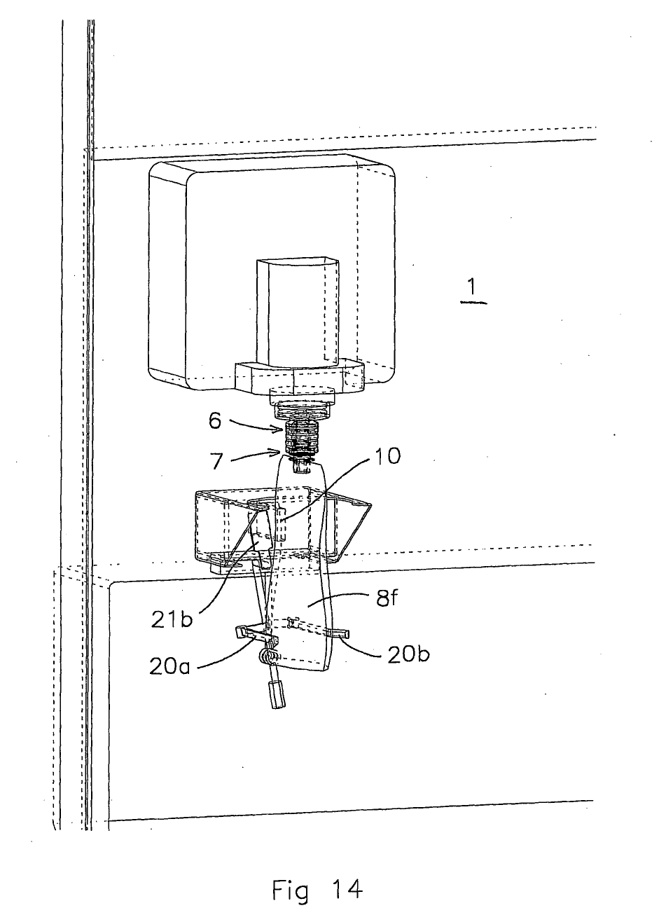

FIG. 14 shows the same embodiment of a combination according to the invention as shown in FIG. 10 with a filled collapsible pouch, and

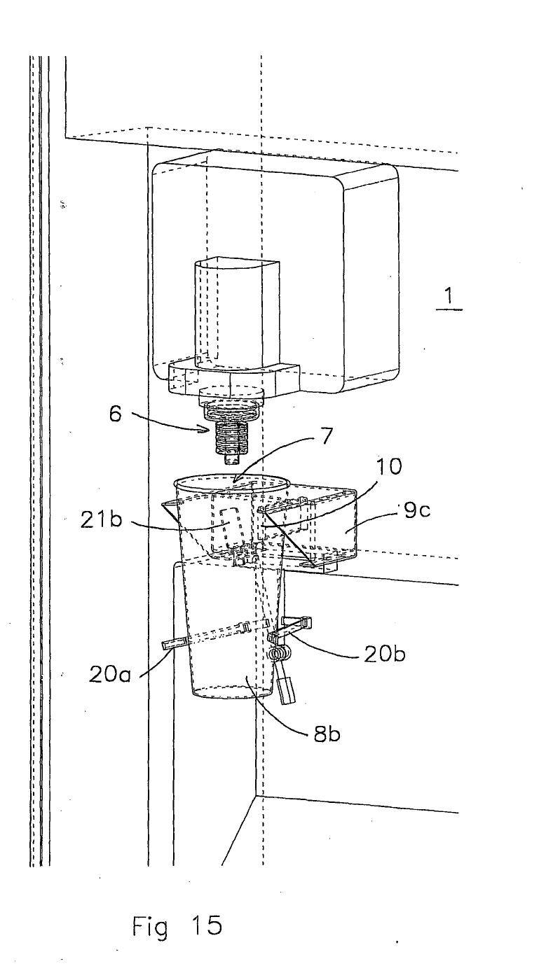

FIG. 15 shows the same embodiment of a combination according to the invention as shown in FIG. 10 with a beaker.

FIG. 1 shows a machine, in general indicated with reference number 1, for making and dispensing a flowable ice product, in this example milk shakes. The machine 1 could also be adapted for other flowable ice product such as e.g. soft ice-cream, ice cream slushes and the like.

The machine 1 comprises an ice product making assembly including a reservoir 3 for the one or more ingredients and a cooler or freezer unit 4, which is connected to the reservoir 3, and which is also connected to a dispenser unit 5. Preferably, the dispenser unit 5 here contains a pump, e.g. an electrically operated pump. Connected to the dispenser unit 5 are outlet means 6 for the milk shake.

FIG. 1 shows a pouch 8a having an inlet means 7, which is held under the outlet means 6 of the machine 1. The inlet means 7 and the outlet means 6 are positioned in such a way that the flowable ice product 2 can be dispensed from the machine 1 to the pouch 8a. Package support means 9a are present to position the pouch 8a appropriately. The milk shake 2 is presented to the customer in the pouch 8a.

The flowable ice product is suitable for human consumption in its flowable form, so that the consumer can consume the ice product from the pouch as it were a beverage.

The pouch 8a is collapsible. The pouch can be made from suitable flexible material, such as plastic film or foil, e.g. multilayer film or foil.

The inlet means 7 can be formed by a suitable plastic body secured in the pouch, which body is generally known as a spout, e.g. in combination with a closure means to close the filling/dispensing opening of the pouch 8a. An example of such a spout will be explained in more detail further below.

FIG. 2 shows a detail of the machine 1 wherein the outlet means 6 are visible. Placed under the outlet means 6 of the machine 1 is another embodiment of a package 8b, embodied as a beaker, with an open top forming the inlet means 7. The support means 9b are embodied as a bearing surface for the bottom of the beaker. A bearing surface 9b can also be used to support a self-standing embodiment of pouch 8a.

Thus FIGS. 1 and 2 show that milk shake is prepared using the machine 1 and can be dispensed as desired into a pouch 8a or a beaker 8b.

In FIGS. 3 and 4 other embodiments of package support means 9c and 9d are shown. In FIG. 3 a known holder 9c, e.g. for beakers, of a milk shake machine is shown, which holder 9c is positioned such that the open top of the beaker is positioned beneath the outlet means 6. In another embodiment, not shown, the inlet means of the pouch can also be positioned in another orientation with respect to the outlet means of the machine, while the ice product still flows from the machine into the pouch.

FIG. 4 shows package support means 9d comprising first support means 9d′ associated with the pouch 8c and second support means 9d″ associated with the machine 1, making it possible to connect the pouch 8c to the machine 1.

FIG. 5 shows a pouch 8d on support means 9b of machine 1 with inlet means 7′, and outlet means 6 of the machine 1. The outlet means 6 of the machine 1 here comprise a nozzle 11. The nozzle 11 is connected to the inlet means 7′ of the pouch 8d forming a fluid-tight passage for the milk shake product 2. The inlet means 7′ in this figure are designed as an integrated inlet-tube, which can for example be made of a relatively rigid material.

In FIG. 6 another possible connection between outlet means 6 of a machine and inlet means 7 of a pouch 8e is shown, making it possible to fill the pouch with ice product. In this embodiment, intermediate means 12 are connected with the outlet means 6 and extend into the inlet means 7 of the pouch 8e. This can for example be advantageous when the intermediate means 12 is a straw that can stay in the pouch 8e after removal from the outlet means 6.

FIG. 7 shows an embodiment of outlet means 6 and inlet means 7′ which can be interconnected. When connected, a pouch such as pouch 8f (shown in FIG. 13) can be suspended from a machine, e.g. machine 1 as shown in FIG. 13. Also, a fluid-tight passage can be formed between the machine and the pouch when connecting the outlet means 6 of the machine with the inlet means 7′ of the pouch.

Here the inlet means 7′ are formed as a plastic spout 14 having a lower spout part 14a to be sealed between opposite walls of the pouch 8f and an upper spout part 14b having a tubular member 14c, which forms the channel for filling the pouch and dispensing milk shake from the pouch. The spout 14 here is adapted to be supsended from the machine 1, in this embodiment by means of one or more external flanges 14d surrounding the tubular member 14c.

The outlet means 6 of the machine 1 comprise a dispensing tube 6a having a fitting 6b connecting the tube 6a to the machine 1.

Associated with the dispensing tube 6a is a releasable securing means 13, securing the pouch 8f with respect to the machine 1 when the tube 6a and the tubular member 14c are interconnected. In this example the tube 6a is designed to fit into the tubular member 14c of the spout.

The securing means 13 are embodied here as a snap connector assembly 13 surrounding the tube 6a. The upper part of the spout 14 can be introduced into this assembly 13 and is then held thereby as a support surface 13b engages beneath one the flanges 14d of the spout 14.

The assembly 13 comprises several segments 13c which are movable outwardly and are disposed in a ring around the tube 6a. Elastic elements 15, e.g. of spring steel of elastic bands 15 are placed around the outside of the segments 13c, here in associated annular grooves 13d.

This design of the inlet means 7′ and the outlet means 6 creates a self-locking connection between the pouch and the machine. The pouch can easily be clicked on the machine.

In FIG. 7 also a screw thread 16 on the spout 14 can be discerned, which can be connected with closure means, in particular a screw cap (not shown) to close off the pouch 8f after filling in a fluid-tight way. The closure means can also have a bayonet catch or the like.

In another embodiment a closure means is integrated with the spout, e.g a movable plug engaging on a seat located in the interior of the pouch.

An example of a closed-off pouch 8f is shown in FIG. 8. The closure means 17 can for example be a screw cap or a bayonet catch, preferably with a size exceeding 28 millimetres. This is to prevent children from accidentally swallowing the closure means 17.

In another embodiment, shown in FIG. 9, the closure means 17 almost completely close off the pouch 8 after filling. A flexible drinking straw 18, connected to the closure means 17, forms an open passage for milk shake.

FIG. 10 shows a part of a machine 1 for producing and dispensing milk shakes having outlet means 6 of a design as described previously when describing FIG. 7. The outlet means 6 can connect to a pouch 8f (see FIGS. 13 and 14) having a spout 14 as described with reference to FIG. 7. Also the outlet means 6 can be used for filling a beaker, when the beaker is placed under the outlet means 6 in the holder 9. In particular the holder 9 supports the upper rim of the beaker.

The machine 1 has a temperature sensor 10 near the holder 9 as is known from existing machines of this type. This temperature sensor 10 senses the temperature of the upper region of the beaker (not shown), for example when 90% of the volume of the beaker is filled. After a signal of this temperature sensor 10 the machine 1 stops to dispense the milk shake.

It was found out that when a generally known type of pouch 8f is being filled using a machine 1 having a temperature sensor 10 as explained above, the temperature sensor 10 senses a low temperature in the upper region of the pouch 8f already from the start of the filling of the pouch. As a result of this, a signal is given to the machine and the dispense of ice product stops too early.

A possibility to overcome this problem is shown schematically in FIG. 11. Here, the pouch is provided with blinding means 21a, that blind the sensor 10 until a desired volume of the pouch 8 is filled. The blinding means 21a are embodied here as an extension of the inlet means 7′ into the interior of the pouch 8. Preferably, the extension 21a is relatively rigid, and extends to across the region where the temperature sensor 10 senses. The ice product will flow through this extension, 21a, and the wall of the extension 21a blinds the sensor 10 from the ice product 2 passing the sensor 10.

Even if the wall of the pouch initially rests against the inlet 7′ and the extension 21, as indicated by the dashed lines, the sensor cannot sense the cold ice product. When the pouch is filled with ice product 2 from the bottom up to the level of the sensor 10, the sensor 10 senses the ice product and give its signal to stop the dispense. To make it possible to completely empty the pouch with ice product, small holes 21a′ are arranged in the extension 21a to simplify the emptying of the pouch 8 with ice product 2.

Another option is to provide mechanical volume detecting means which respond to a volume expansion of the pouch and give a signal when the pouch is sufficiently filled. In an embodiment, not shown, an empty pouch is placed between two pouch engagement members. The pouch engagement members are initially spaced apart by a distance x. The empty pouch, being almost flat, will fit easily between the pouch engagement members. When being filled the pouch will expand and push the pouch engagement members apart, increasing the distance x. A particular distance increase corresponds to a known amount of filled volume. Such mechanical means can give a signal to the machine after which the machine stops to dispense the ice products.

In FIG. 10 another possibility to overcome this problem is shown, by providing the machine 1, having a temperature sensor 10, with blinding means 21b. The blinding means blind the temperature sensor 10 until a desired volume of the pouch 8 is filled. When, if the desired volume of the pouch is filled, the blinding means 21a are moved from their initial position, the temperature sensor 10 can give a signal to the machine to stop the dispense of ice product. In the embodiment shown in FIG. 10 the blinding means 21b are connected to mechanical means 20 that respond to a volume expansion. This way, a desired volume expansion, sensed by the mechanical means 20, results in the movement of the blinding means 21b that blinded the temperature sensor 10, after which the sensor 10 senses the cold produced by the ice product 2 in the pouch and will give a signal to stop the dispense. In this embodiment the mechanical means 20 include two pouch engagement members, embodied here as bars 20a and 20b, between which the pouch 8f can be placed. Here the bars are spaced over a distance x in the horizontal plane and extend perpendicular to the front face machine 1. Bars 20a, 20b are each connected pivoting about essentially vertical axis to bars 20c and 20d. Between the bars 20a and 20b a pouch 8f can be placed that expands when being filled.

The connection between the blinding means 21b and the mechanical means 20a-d is made here by a set of two vertical bars 22a and 22b. Blinding means 21b are connected to a bar 22a that can pivot around a pivot 22c. At the end opposite to the end where the blinding means 21b are connected to a counterweight 22d is connected. To this bar 22a, a set of bars 20a and 20c from the mechanical means are connected. The other set of bars 20b and 20d are connected to the other vertical bar 22b, which is connected to the pivot 22c and to the package support means 9c. Hence, this bar 22b is fixed and can not pivot. As mentioned above, bars 20a, 20b are connected pivoting to bars 20c and 20d. In this construction, however, the distance between bars 20a and 20b can also increase as a result of the pivot of bars 22a and 22b around pivot 22c. Hence, it is not necessary for the bars 20a and 20b to be connected pivoting to the bars 20c and 20d. However, to fine tune the relation between the sensed volume expansion by the mechanical means 20 and the removal of the blinding means 21b, it can still be desirable to make this connection pivoting. It is also necessary when it is desired that a beaker, such as shown in FIG. 2, can also be fitted between the bars 20a and 20b.

In another embodiment (not shown) is the bar 22b connected directly to the machine 1.

The operation of this set of mechanical and blinding means, indicated by the numbers 20-22, is shown in FIG. 12. The distance between the bars 20a and 20b has increased to x+y, as a result of which the vertical bar 22b has pivoted around pivot 22c and removed the blinding means 21b from the temperature sensor 10.

FIG. 13 shows the combination according to the invention with a machine 1 and an empty pouch 8f. The pouch 8f fits between the bars 20a and 20b and is connected with its inlet means 7 to the outlet means 6 of the machine.

In FIG. 14 the pouch 8f is filled and has expanded. As a result of this, the distance between the bars 20a and 20b has increased and the blinding means 21b no longer blind the temperature sensor 10. As a result the sensor 10 now sees the cold pouch and stops the dispensing of milk shake.

An advantage of the construction as described above is that the machine with the additional mechanical and blinding means construction (indicated by the numbers 20-22) can be used both to dispense ice products to a beaker and to a pouch. In FIG. 15 the same combination according to the invention is shown with a beaker 8b in the holder 9c. The ice product 2 can be filled to the inlet means 7 of the beaker from the outlet means 6 of the machine 1. By placing the beaker 8b in the holder 9c, the bars 20a and 20b are pushed apart, thereby removing the blinding means 21b from the temperature sensor 10.

1-41. (canceled)

42. Method for vending a flowable ice product to a consumer at a vending location, said method including:
providing at said vending location a machine for making and dispensing said flowable ice product, said machine comprising an ice product making assembly including a cooler or freezer unit, and a dispenser unit for dispensing the ice product, which is connected to the ice product making assembly and to an outlet of the machine;
providing a collapsible pouch for the flowable ice product, said pouch having an inlet;
interconnecting the inlet of said pouch and the outlet of the machine;
dispensing said flowable ice product from the machine into the pouch thereby filling the pouch to obtain a filled pouch; and
disconnecting said inlet of the filled pouch from the outlet of the machine and presenting said filled pouch to said consumer.

43. Method according to claim 42, wherein said flowable ice product is a selected from the group of milkshake and soft-ice cream.

44. Method according to claim 42, said method further including providing a closure means for said inlet of the pouch and arranging said closure means to close off the filled pouch before presenting said filled pouch to said consumer.

45. Method according to claim 42, wherein said pouch comprises a spout forming said inlet of the pouch.

46. Method according to claim 45, wherein said pouch comprises a spout forming said inlet of the pouch and wherein said spout is provided with an integrated closure means, and wherein the filled pouch is closed off by said closure means before presenting said filled pouch to the consumer.

47. Method according to claim 42, wherein said pouch is suspended from said outlet of the machine by interconnecting said inlet of the pouch and said outlet of the machine.

48. Method according to claim 42, wherein said machine comprises self-locking pouch securing means, and wherein said pouch is suspended from the outlet of the machine by said self-locking pouch securing means engaging on said inlet of the pouch.

49. Method according to claim 42, wherein the machine is adapted to allow for placement of a beaker beneath the outlet of the machine, and the method includes selectively dispensing said flowable ice product into said beaker when no collapsible pouch is interconnected to said outlet of the machine or into said collapsible pouch when said inlet thereof is interconnected to said outlet of the machine.

50. Method according to claim 42, wherein the machine comprises control means that provide a signal to stop the dispensing of ice product from the machine to the pouch.

51. Method according to claim 50, wherein the control means comprise volume detection means that detect a filled volume of the pouch.

52. Method according to claim 50, wherein the control means comprise a temperature sensor, which senses the temperature of an upper region of the pouch.

53. Method according to claim 50, wherein the control means comprise mechanical means that respond to a volume expansion of the pouch.

54. Method according to claim 50, wherein the control means comprises mechanical means that respond to a volume expansion of the pouch, which mechanical means provide a signal to stop the dispensing of flowable ice product, and wherein the mechanical means comprise two pouch engagement members, which are adapted to engage on opposite sides of the pouch and are movable away from each other upon filling of the pouch.

55. Method according to claim 50, wherein the machine comprises a temperature sensor, which senses the temperature of an upper region of the pouch and which provides a signal to stop the dispensing of flowable ice product, and wherein blinding means are provided that blind the temperature sensor temporarily during filling of said pouch, until a predetermined volume of the pouch is filled.

56. Method according to claim 55, wherein the blinding means are integrated with the pouch as an extension member of the inlet into the interior of the pouch, which extension member extends across a region of the pouch of which the temperature is sensed by the temperature sensor.

57. Method according to claim 55, wherein the blinding means are connected to the machine and are connected to mechanical means that respond to a volume expansion of the pouch, in order to remove the blinding means from the temperature sensor when a desired volume expansion of the pouch is achieved.

58. Method according to claim 57, wherein the mechanical means remove the blinding of the temperature sensor upon placement of a beaker beneath the outlet means of the machine.

59. Method according to claim 58, wherein the mechanical means for measuring volume expansion and blinding the temperature sensor are designed as follows:
one vertical bar, connected to the pouch support means, to which in the mid-way region an arm is connected, composed of two bars, one arranged horizontally, parallel to the machine, of which one end is connected to the vertical bar, and the other end is connected to the second arm-bar, which extends perpendicular both to the machine and to the horizontal bar, and
a second vertical bar, connected hinging to the first vertical bar, at one end of which the blinding means are connected which are placed, at rest, in front of the temperature sensor, at the other end of which a counterweight is connected, and in the mid-way region of which a second arm is connected, extending the opposite direction of the first arm, also composed of two bars, one of which is arranged horizontally, parallel to the machine, of which one end is connected to the vertical bar, and the other end is connected to the second arm-bar, extending perpendicular to both the machine and to the horizontal bar.

60. Method according to claim 42, wherein the machine comprises an ice product freezing barrel.

61. Method according to claim 42, wherein the machine stops to dispense the flowable ice product upon a signal derived from a temperature sensor that senses the temperature in an upper region of the pouch.

62. Method according to claim 42, wherein the machine stops to dispense the flowable ice product upon a signal derived from mechanical means that sense a volume expansion of the pouch.

63. Method according to claim 42, wherein the machine stops to dispense the flowable ice product upon a signal from a temperature sensor, which was initially blinded by blinding means, that are connected to mechanical means that sense a volume expansion of the pouch, which blinding means move away from the temperature sensor when a predetermined volume expansion of the pouch has been reached.

64. Method according to claim 42, wherein the pouch has a volume between 100 and 500 ml.

65. In combination:
a machine for making and dispensing a flowable ice product comprising an ice product making assembly including a cooler or freezer unit, and a dispenser unit for dispensing the ice product, which is connected to the ice product making assembly and to an outlet of the machine, the machine being adapted to allow for placement of a beaker beneath the outlet of the machine, and
a collapsible pouch for the flowable ice product, said pouch having an inlet, said inlet being interconnectable to the outlet of the machine, so that flowable ice product is dispensed from the outlet into said beaker when no collapsible pouch is interconnected to said outlet of the machine or into said collapsible pouch when said inlet thereof is interconnected to said outlet of the machine.

66. In combination:
a machine for making and dispensing a flowable ice product comprising an ice product making assembly including a cooler or freezer unit, and a dispenser unit for dispensing the ice product, which is connected to the ice product making assembly and to an outlet of the machine, and
a collapsible pouch for the flowable ice product, said pouch having an inlet, said inlet being interconnectable to the outlet of the machine, so that said flowable ice product can be dispensed from the outlet of the machine into the pouch.

67. The combination of claim 66, wherein said machine is a milkshake machine that allows to make and dispense milkshake.

68. The combination according to 66, wherein the machine is adapted to hold the pouch suspended from the machine when said inlet and outlet are interconnected.

69. The combination according to claim 66, wherein the inlet of the pouch and the outlet of the machine are interconnectable to suspend the pouch from the machine.

70. The combination of claim 66, wherein the machine is provided with self-locking pouch securing means which engage on the inlet of the pouch to suspend the pouch from the machine.

71. The combination of claim 66, further comprising a closure associated with the inlet of the pouch to close off the pouch.

72. The combination according to claim 71, wherein the closure is a cap.

73. The combination according to claim 71, wherein a straw is connected to the closure.

74. The combination according to claim 66, wherein the collapsible pouch comprises a spout sealed between opposite walls of the pouch.

75. The combination according to claim 66, wherein the pouch comprises a thermally insulating shell.

76. The combination according to claim 75, wherein the shell comprises a foam layer.

77. The combination according to claim 66, wherein the machine comprises control means to control the dispensed amount of flowable ice product, said control means being adapted to provide a signal to stop the dispensing of flowable ice product from the machine to the pouch when a predetermined volume of the pouch is filled with ice product.

78. The combination according to claim 77, wherein the outlet of the machine is adapted to connect to the inlet of the pouch so that the pouch is suspended from the outlet and wherein the control means comprise a temperature sensor, which senses the temperature of an upper region of the pouch.

79. The combination according to claim 66, wherein the machine comprises mechanical means that respond to a volume expansion of the pouch, which mechanical means provide a signal to stop the dispensing of flowable ice product, wherein the mechanical means comprise two pouch engagement members, which are adapted to engage on opposite sides of the pouch and are movable away from each other upon filling of the pouch.

80. The combination according to claim 78, wherein the machine further comprises blinding means that blind the temperature sensor temporarily during filling of a pouch, until a predetermined volume of the pouch is filled.

81. The combination according to claim 80, wherein the blinding means are connected to the machine and are connected to mechanical means that respond to a volume expansion of the pouch, in order to remove the blinding means from the temperature sensor when a desired volume expansion of the pouch is achieved.

82. The combination according to claim 81, wherein the mechanical means are adapted to remove the blinding of the temperature sensor upon placement of a beaker beneath the outlet of the machine.
